(19) United States
(12) Patent Application Publication
(10) Pub. No.: US 2008/0219448 A1
(43) Pub. Date: Sep. 11, 2008

(54) Multiple-layers encryption/decryption and distribution of copyrighted contents

(76) Inventor: John Almeida, Berkeley, CA (US)

Correspondence Address: LOUIS VENTRE JR, 2483 Oakton Hills Dr., OAKTON, VA, 22124, US

(21) Appl. No.: 11/682,313

(22) Filed: Mar. 6, 2007

(51) Int. Cl. H04L 9/00

(52) U.S. Cl. 380/277

(57) ABSTRACT

A method and an apparatus for providing multiple-layers of encryption/decryption of contents and the transferring of protected content between devices based on each device's multiple IDs. Furthermore, it related to a two-way secure communication between two or more devices. The encryption/decryption is based on a common content ID that is used for providing multiple layers of encryption that can be used by hardware and software. Each byte of the digital stream is XORed with each byte of the content ID thus providing the encryption strength. The same process is applied to the encrypted content (ciphertext) thus reproducing the plaintext. As well, means for encrypting/decrypting digital content using its plain byte values as part of the content private key's registers.

### BACKGROUND OF INVENTION

1. Field of the Invention

The field of this invention relates generally to a method and an apparatus for providing multiple-layers of encryption/decryption of contents and the transferring of protected content between devices based on each device's multiple IDs. Furthermore, it relates to a two-way secure communication between two or more apparatus.

2. Prior Art

The prior art U.S. Pat. No. 6,907,126 invented by Takeshi Inada and assigned to NEC Corporation teaches a method for an encryption-decryption apparatus, a transmitting apparatus encrypts input data to output encrypted data. A network transmits the encrypted data. A receiving apparatus takes as input the encrypted data transmitted through the network, and decrypts the data to send output data. A variable configuration processing circuit encrypts the input data. A ROM outputs circuit data serving as a secret key to the variable configuration processing circuit. Another variable configuration processing circuit decrypts the encrypted data. Another ROM outputs circuit data serving as a secret key to the variable configuration processing circuit. This enables a change in hardware according update of an encryption-decryption algorithm, and more rapid processing of the encryption-decryption operation.

Although Inada '126 teaches an apparatus for encrypting and decrypting data using a group of ROMs (Read Only Memory) as the private-secrete key and providing a fast means for the same. It does not however teaches any means of generating a content key and using it at as an input to the encrypting circuitry without having to replace the hardware circuitry (ROM) in terms of providing new encryption means. Inada's 126 is hard and costly to implement thus rendering it incapable for every day use as it is required for protecting personal data, for two-way and network communication.

It is the object of the present invention to advantageously provide an advanced way for protecting personal data, network, two-way communication and copyrighted content exchange between devices without the high cost and complexities currently available and without degrading security. It is a further objective of the present invention to provide means for encrypting data at the hardware and/or software level using an easy to generate content key and the same functionality is used for the sender and the receiver apparatus. The content key is used by the apparatus circuitry as a means to provide the encryption strength, wherein each byte of the plaintext data is XORed by each byte of the content key.

It is a further objected of the present invention, in addition to the content private key, to use a dual ID for each apparatus as to enable encrypted copyrighted contents to be transferred between two or more devices without the possibility of infringing content's rights. A check sum algorithm or any other algorithm for the same purpose is used for providing individual key-values for the apparatus' postal service address location and the apparatus' owner name and each key-value representing an ID for each apparatus and they both are used in conjunction with the encrypting means as to enable/disable content transfer between apparatus.

### SUMMARY OF THE INVENTION

It is the object of this invention to demonstrate a method and an apparatus for providing a high encryption strength for use in hardware and/or software as to enable the encryption/decryption of contents based on each content private key. The private key can be a key that is easily generated by any means for generating random values and the private-key value is used to encrypt/decrypt and for the encryption strength. Each byte value of the plaintext string (un-encrypted string) is XORed with each byte value of the content's private key. The plaintext's byte value is XORed with the first byte value of the private key then its resultant value is re-XORed with the next byte value of the private key, the process will be repeated for each byte value of the private key. The same process is used for the decryption of the ciphertext (encrypted content).

If it is used in a hardware circuitry, the private key byte values are placed on registers and each bit of each byte value is XORed with each bit of each byte value of the content's private key. The resultant value of the electronic XORed values become the input to the next set of XOR gates along with the set of individual bits of the next byte value of the content private key, thus, re-encryption is achieved for all the values of the private key bytes. The final value is the ciphertext, this process is fast since it is done in circuitry level and it can be used for any kind of security including but not limited to: network and two-way communication, securing personal content on computer, securing copyrighted content, etc. To decrypt, the same circuitry can be used with the same content key that was originally used for the encryption process and the final output byte will be the decrypted byte value of the original plaintext. In case this invention is used for two-way communication, the two devices taking part of the communication link can exchange a common key by using algorithms like Diffie-Hellman Algorithm and it will be explained shortly.

It is the desire of the copyrighted content industry to have a reliable means for distributing content without hindering legitimate content user and protecting its investments against content piracy. And as it will be taught shortly, it is one further object of the present invention to achieve the just described scenario. Each device hosting/transferring a copyrighted content will have two individual Ids and they both will enhance protected-copyrighted content distribution. One of the ID is based on the postal address of the device's location and it can be based on a checksum of the device's address like, city, street, state abbreviation, zip code, country, etc., and the second can base on the devices owner profile information like, name, date of birth, nick name, etc. Both ids can be a checksum byproduct of the entire information as just depicted herein or it can be just one element of the provided information. Other means ca be used as well without departing from the true spirit and scope of present invention.

As aforementioned, a private key will be generated for individual content and used for encryption/decryption. Furthermore, each device will have two Ids, one for the device's address and the other for the user's profile. Once an encrypted content is stored in a device the content-private key will be used by a device for decrypting the content before its use. Now, in case the protected content needs to be transferred to another device the two ids of the device hosting the content is used along with the receiving device's two ids as well. If any of the two keys (Ids) on both devices produces a match, the content can be transferred to the receiving device. If none of them produces a match, the transfer is thus inhibited. For instance if two devices are on the same address they can exchange protected content, or, if two devices belongs to the same individual they can exchange protected content as well, on the other hand, if two or more devices having distinct addresses and distinct owners, they will not be able to share protected contents.

### BRIEF DESCRIPTION OF THE DRAWINGS

The accompanying drawings, which are incorporated in the form a part of this specification, illustrate embodiments of the invention and, together with the description, serve to explain the principles of the invention:

FIG. 1 illustrates a preferred embodiment of this invention in which an electronic circuitry using XOR is used for the encryption process involving the content's private key and the content's byte values.

FIG. 2 illustrates a preferred embodiment of this invention in which an electronic circuitry using XOR is used for the decryption process involving the content's private key and the content's byte values.

FIG. 3 illustrates a further embodiment of FIG. 1.

FIG. 4 and FIG. 5 illustrate a preferred embodiment of the present invention using a byte value from the plaintext to be part of the registers and be used to encrypt the next plaintext's byte.

FIG. 6, FIG. 7 and FIG. 8 illustrate further embodiment of FIG. 4 and FIG. 5 using a decrypted byte to be part of the registers and be used to decrypt the next encrypted byte value.

FIG. 9 illustrates another preferred embodiment of this invention in which an electronic circuitry using comparators to compare the device-address keys-1 producing an exactly match.

FIG. 10 illustrates another preferred embodiment of this invention in which an electronic circuitry using comparators to compare the device-user keys-2 producing a mismatch.

FIG. 11 illustrates the final electronic stage where the two device's keys will enable/disable content transfer between two devices.

FIG. 12 illustrates a flowchart of the representation of FIG. 11.

FIG. 13 illustrates two arrangements of content hosts transferring protected content to a device and the device transferring the same content to a secondary device.

FIG. 14-16a illustrates XOR tables and used for explaining XOR operations.

FIG. 17 illustrates digital electronic gates and tables representing their respective inputs and outputs.

FIG. 18 illustrates Internet communication and an apparatus electronic circuitry.

### DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

As will be appreciated by those of skill in the art, the present invention may be embodied as a method or a computer program product. Accordingly, the present invention may take a form of an entirely software embodiment or an embodiment combining software and hardware. Furthermore, the present invention may take the form of a computer program product on a computer-readable storage medium having computer-readable program code means embodied in the medium. Any computer readable medium may be utilized including but not limited to: hard disks, CD-ROMs, optical storage devices, or magnetic devices. Furthermore, the present invention can be embodied in an apparatus electronic circuitry and for communication between any electronic devices, in network, two-way communication and copyrighted content protection.

Also, any reference to names of a product or of a company is for the purpose of clarifying our discussion and they are registered to their respective owners.

In a preferred embodiment the present invention a method and an apparatus for providing content protection for copyright holders and for protecting communication between devices will be presented as to enable those of the skill in the art to practice the invention. As it is well known to those of the skill in the art, the explanation given herein will be for an apparatus, however the same teaching can be used in a software program as well. A randomized key of some sort can be generated and used for encryption and decryption of contents.

In another preferred embodiment of the present invention the plainbytevalue is encrypted then it is integrated with the content key and placed at the end of the content-key registers and used to encrypt the next plainbytevalue. This process will be used throughout the encrypting of the digital content stream. Every byte of the digital content stream is used as part of the encryption. The first plainbytevalue is encrypted using only the content key; all other bytes will use other(s) plainbytevalue of the digital content stream. As a plainbytevalue is inserted to the end of the content-key register, the content-key register is shifted to the left as to accommodate the new byte value into it, the same process is applied for decryption.

The content key (private key) will be used by the apparatus and it will be implemented in a series of registers, one byte each, and each byte of the content where protection is to be applied thereupon will be encrypted with each byte of the register's byte chain, starting with the first byte and its result will feed the next series of XOR gate sequence until all bytes of the register-chain is used and the final result will be the encrypted content's byte value.

For the sake of our explanation, lets assume that there are a total of four bytes for the content-key, furthermore, lets assume that only one byte will be encrypted. The content's byte will be encrypted, that is, XORed with the first byte of the content key and starting with the first bit to the last bit of each byte (from the most significant bit to the least significant bit, the opposite can be used as well), the same bit position of each byte (content's byte and content's key byte) value will be used in an XOR gate circuitry. Its result is fed into the next set of XOR gate circuitry and the bits of the next content's key byte value will be XORed once again with the previous XOR values of the previous XOR gate circuitry operation, thus, encrypting it for the second time. This process will be repeated for the third and the forth byte as well and the output from the forth byte will be the final encrypted byte value. In the just given explanation, the byte will be encrypted four times. In an actual apparatus the key will be of a much larger and since the encryption is done in a hardware-circuitry level, its speed will be linear for various key length.

The security method just taught can be used by any kind of apparatus in any conceivable way, for the sake of an example, lets assume that two two-way communication devices are using the teaching of this invention. The two devices can be arranged to exchange a common key by using diffie-hellman key exchange algorithm, or any other algorithm for that matter, and the exchanged private keys can be used as the content key and be stored in the electronic-register chain for the duration of the communication, and since the same circuitry is used for encryption and decryption, costs will be reduced for the device's production and efficiency will be increased without degrading security.

In addition to the above teachings regarding content protection using a content key for encryption and decryption, the device can be arranged as to produce two Ids using a check sum for the device's address location (home address) and for the devices owner's profile as to enable two or more devices to exchanged protect copyrighted content without infringing content's rights and thwarting content piracy. The just described methodology can be employed in the device's circuitry or be implemented using software stored in the device ROM (Read Only Memory) or any other means for storing data on a device.

Checksum Theory

A checksum algorithm is an algorithm used to produce mathematical sum representing a section of data, a data file, string, data packets, digital stream, etc. Before we proceed any further lets give an example of a checksum for purpose of clarity, we'll be using the Adler-32 sum of the ASCII string “HELLO” and it would be calculated as follows:

| ASCII Code | String A | String B |
|---|---|---|
| H = 72 | 1 + 72 = 73 | 0 + 73 = 73 |
| E = 69 | 73 + 69 = 142 | 73 + 142 = 215 |
| L = 76 | 142 + 76 = 218 | 215 + 218 = 433 |
| L = 76 | 218 + 76 = 294 | 433 + 294 = 727 |
| O = 79 | 294 + 79 = 373 | 727 + 373 = 1100 |

String Checksum=3731100 (the values 373 and 1100)=>HEX=38EE9C

Each byte is represented as a value by a computer and in our example the bytes are letters of the Latin alphabet and they are represented by values of an alphabet table called ASCII (American Standard Code for Information Interchange). Each alphabet is represented by a table and having distinct value for each character of the represented alphabet. HEX (Hexadecimal) values are ways of converting values into the 16-value range format used to represent 0-9 (for 0-9) and for 10-15 (for A-F).

Diffie-Hellman Key Exchange Theory

Communicating “in the clear”, Alice and Bob select two numbers, The simplest, and original, implementation of the protocol uses the multiplicative group of integers modulo p, where p is prime and g is primitive mod p. Modulo (or mod) means that the integers between 0 and p−1 are used with normal addition, subtraction, multiplication, and exponentiation, except that after each operation the result keeps only the remainder after dividing by p. Here is an example of the protocol:
1. Alice and Bob agree to use a prime number p=23 and base g=5.
2. Alice chooses a secret integer a=6, then sends Bob (ga mod p)*(5)⁶ mod 23=8.
3. Bob chooses a secret integer b=15, then sends Alice (gb mod p)*(5)¹⁵ mod 23=19.
4. Alice computes (gb mod p)a mod p*(19)⁶ mod 23=2.
5. Bob computes (ga mod p)b mod p*(8)¹⁵ mod 23=2.

Both Alice and Bob have arrived at the same value, because gab and gba are equal. Note that only a, b and gab=gba are kept secret. All the other values are sent in the clear. Once Alice and Bob compute the shared secret they can use it as an encryption key, known only to them, for sending messages across the same open communications channel. Of course, much larger values of a,b, and p would be needed to make this example secure, since it is easy to try all the possible values of gab mod 23 (there will be, at most, 22 such values, even if a and b are large). If p was a prime of at least 300 digits, and a and b were at least 100 digits long, then even the best known algorithms today could not find a given only g, p, and ga mod p, even using all of mankind's computing power. The problem is known as the discrete logarithm problem. Note that g need not be large at all, and in practice is usually either 2 or 5.

Electronic Gates Operation Theory

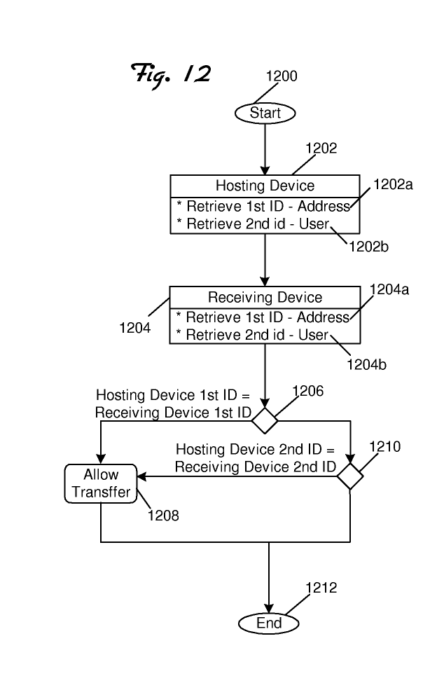

Before going any further, lets review how encryption can be performed into a string. There are many ways of hiding the original content (plaintext) and at the process getting the encrypted text (ciphertext). Some use means for scrambling the plaintext, others use mathematical formulas, algorithms, XOR, addition/subtraction, etc. For our encryption method we'll be using the XOR method. As we turn to FIG. 14 it shows two values being XOR-ed. The top value of “9” 1400 is XOR-ed with the bottom value of “7” 1410. The XOR process uses the binary representation of the values that it will process, that is, XOR. Each value processed by a computer is represented in its bytes equivalent (8 bits), since this is the only way a computer can perform its operation, and it is by using 0's and 1's (bits). For instance the value of “9” is represented by the byte value of “00001001” and the value of “7” is “00000111”. For our examples we're ignoring the four leftmost values since our examples uses small values. The same can be done using addition for encryption and subtraction for decryption, the objective still the same. XOR is the most used since the resultant value is the same length of the two values being XOR-ed and computer are good in doing XOR operations since it involves comparisons.

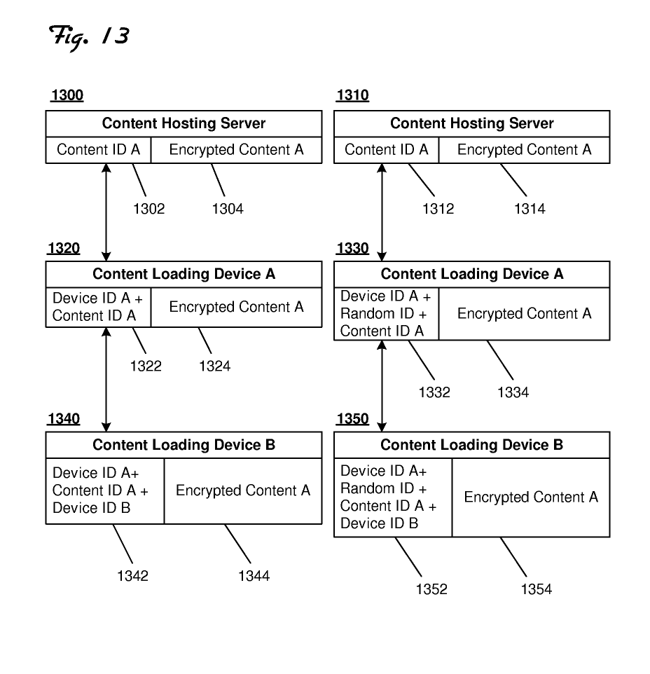

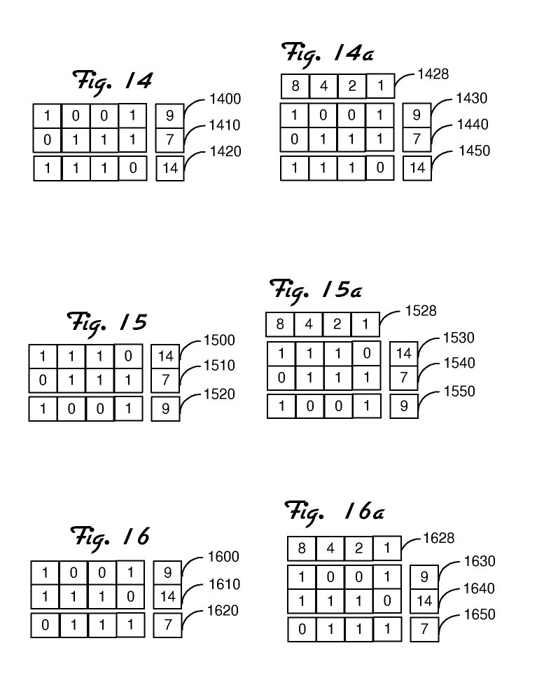

Now the XOR operation will produce the value of “1” any time at least one of the XOR-ed values has a byte value of 1's for one bit and a 0's for the other bit, and for all other bits combinations, its results will be 0's. Once two values are XOR-ed and the XOR result is applied to either of the original values in a second XOR operation, the operation result will produce the missing value—the value not taking part of the XOR operation. For example, FIG. 14 top value is “9” 1400 and the next value is “7” 1410 and the XOR result is “14” 1420. Lets move to FIG. 15. Now, once the result “14” 1500 is XOR-ed to the result of “7” 1510 the result will be “9” 1520. FIG. 16 shows the opposite. When the value of “14” 1610 is XOR-ed to the value of “9” 1600 the result will be “7” 1620.

Since we've already discussed that 0's and 1's are the representation of computer operation, lets review FIG. 14a. The top 1428 has the values starting from the right to the left, “1248”. In a binary representation it starts from the right (lower values) to the left (higher values). Since computers only deal with 0's and 1's, the first right most bit has the value of “1” and each of the following bit to the left will have the value of the first bit multiplied by “2” and the next value will be twice as large as the previous right value. And at any time there is the value of “1” for the bit, it will be added to any other value of “1” for any subsequent bit of the byte value. For instance, the value “9” 1430 has a “1” for the first bit “1” and for the last bit “8”, in this case, the value of “1” is added to the value of “8” and the resultant value is “9”. One more example and it will be clear. Next the value of “7” 1440 has 1's for the first three bits, “1”, “2” and “4”, and their sum is “7”. FIG. 14a represents the values for FIG. 14, the same applies to FIG. 15a and it has the values for FIG. 15 and FIG. 16a has the values for FIG. 16.

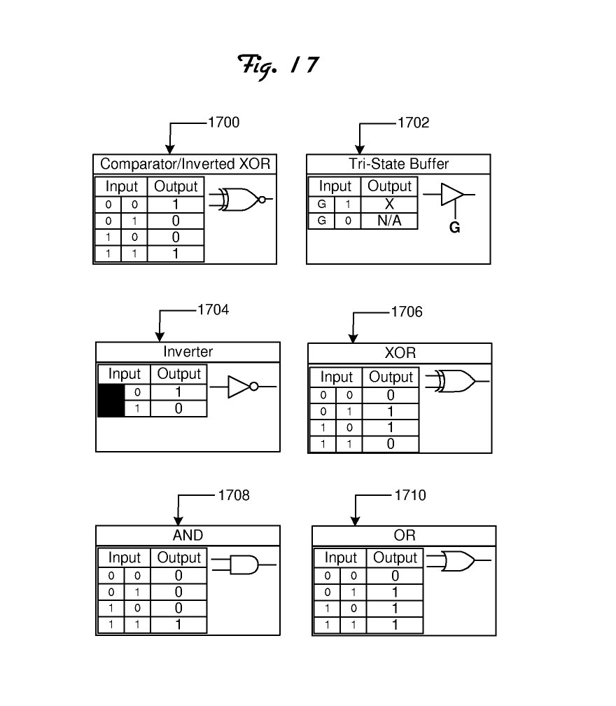

Lets turn our attention to FIG. 17 and it illustrates tables for the digital-logic gates that we will be using in the present invention. Since we've already explained the XOR logic gate theory—it is illustrated at table 1706. Lets briefly review a few other digital logic gates that we'll be using herein. To the left of each table we see the input and to the right it's output, and each one function differently. Lets start with the Comparator 1700 and for the inputs of two “0” or two “1” it will have an output of “1” and for all other combinations for it's input, it will have a “0” for it's output, the Comparator is an XOR with an inverter at its output—inverter will be explained shortly. The Tri-state buffer 1702 has an input, an output and a gate, if the gate “G” is “1” the input will be allowed to pass to the output without any constraint, that is, the same input value will be the same output value. If on the other hand, “G” is “0” the input will not be allowed to pass and it's output will show a high-impedance, that is, it can be consider disconnected from the circuitry, as well, it can be considered turned off.

The Inverter 1704, it's output will simply be the inverse of its input, if “0” for the input it's output will be “1”, if “1” for it's input it's output will be “0”. An inverter can be placed on any logic gate to change the signal's value and once it is placed in other circuitry, its designation will be a circle attached to the logic gate, as it is illustrated on table 1700. The XOR 1706 and it has already been explained, the output of an XOR will produce a “1” whenever both of its input has a distinct value each, and it will have a “0” for its output whenever both of its input has two exactly values. The AND gate 1708 has for its output the value of “1” only when both of its input is “1” and “0” for all other input combinations. Finally, the OR gate 1710 and it will have “0” for its output only when both of its input are “0” and one for all other input combinations.

Apparatus and Internet Communication

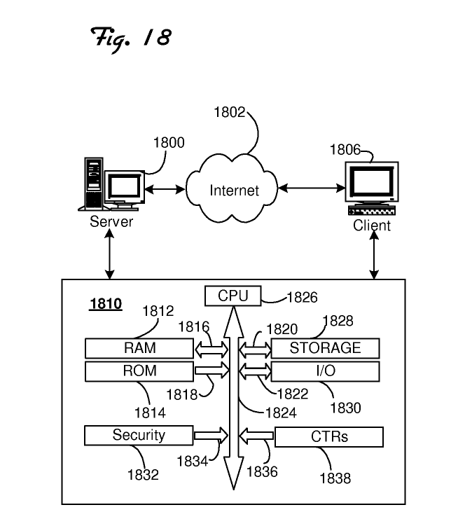

Before going any further, lets review Internet communication and as we turn our attention to FIG. 18, it illustrates a server 1800, the Internet 1802 and a client computer 1806. The Internet channel 1802 is the communication channel between the client 1806 and the server 1800. The client 1806 initiates a request for contents from server 1800 and it returns contents thereafter. The Internet is the transport vehicle for transporting data between the two computers. Each computer of the illustrated arrangement, the server 1800 and the client computer 1806, each has an electronic processing unit 1810 responsible for its functionalities.

The electronic unit 1810 may or may not have all the components, or may have more components than those depicted thereon. In any case each will have at least some basic electronic units like the CPU 1826 and it is the brain of the device responsible for all of the device's functionalities. At power up, the CPU 1826 loads instructions from ROM 1812 and the instructions will instruct the CPU 1826 to load an Operating System (OS) from the storage unit 1828 (it can be a magnetic disc, CD ROM, etc) into RAM 1812. As needed the electronic device will communicate to outside environment through its I/O port 1830 and in the case of the illustrated devices, it can be a network card that allows communication using the Internet.

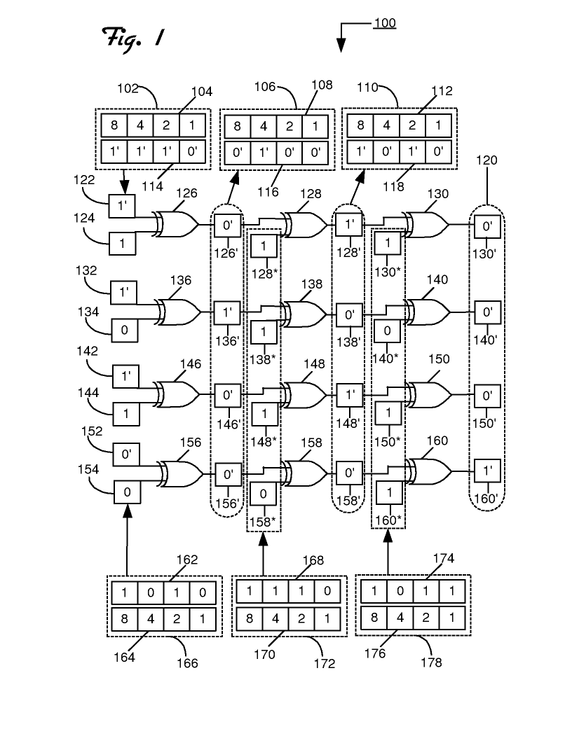

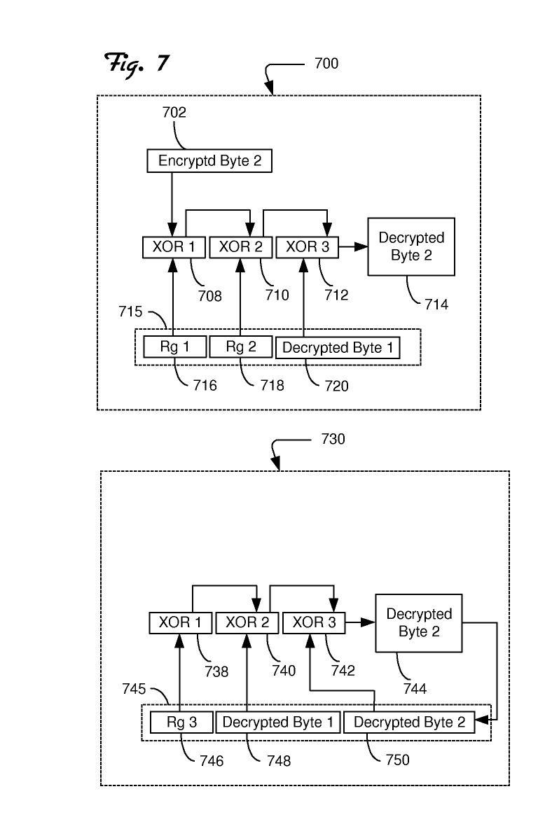

The CPU 1826 communicate differently with each of its connected electronic unit, in some cases the communication and interaction is two-ways and in other instances, one-way. As for the illustrated device 1810 the CPU 1826 does a one-way communication with the ROM 1814, Security 1832 and CTRs (Content Transfer Registers) 1838 (one-way arrows 1818, 1834 and 1836) unit and two-way communication with all other devices as indicated by the two-way arrows (1816, 1820, 1822 and 1824). As it is clear to those of the skill in the art, each device will have input means as well, like a mouse, keyboard, and other visual interfacing means like a screen, etc. Now, Registers 1838 and Security 1832 corresponds to the modules of the present invention, the Security module represents the teachings of FIG. 1-8 and the CTRs represents the teachings of FIG. 9-11.

Encryption of the plainbytevalue

Lets turn our attention to FIG. 1 and it illustrates a preferred embodiment of this invention. We'll be using a four bits value for our exemplary explanation for sake of simplicity and since we'll be using small values, in a real application an eight bits value (one byte) is used. A device 100 having a byte to encrypt 102 and a set of registers 166, 172 and 178. Registers 166, 172 and 178 are the content's private key and it is used for providing the encryption strength. In a real application it will be much longer than just three registers, the more registers the stronger the encryption will be. Although we're using a half-byte value, we'll be calling a byte value for sake of easy of understanding, since a half-byte is called “nibble” and it is not a well-known term for most people. As well, when referring to a value that is still in its original form, we'll be calling it “plainbytevalue” and once it is XORed with other value it will be called “cipherbytevalue”.

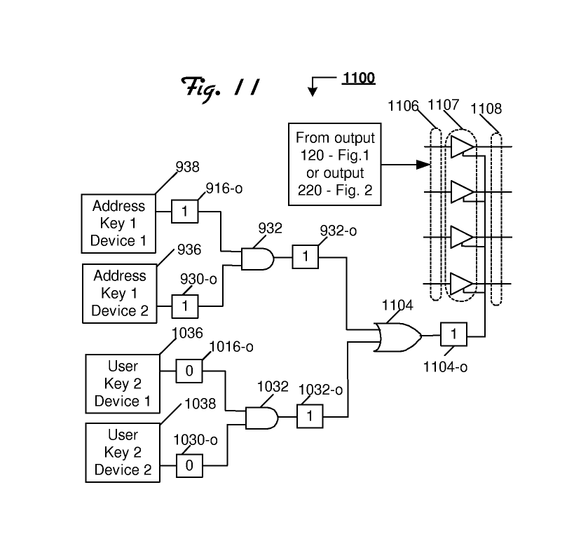

Proceeding with device 100 and as we analyze the plainbytevalue of byte value 102 at its top row 104 it depicts the bits position values as it was explained for FIG. 13-15a; at the bottom 114 it depicts the actual bits value in relation to the top positions 104. The same explanation applies to cipherbytevalue boxes 106 and 110. As for registers 166, 172 and 178 the bits positions values are at the bottom of the box, 164, 170 and 176; and for the bits values are at the top of the boxes 162, 168 and 174.

As we further review FIG. 1 it illustrates three groups of XOR gates and they are: 126, 136, 146 and 156[1]; 128, 136, 148 and 158 [2]; 130, 140, 150 and 160 [3]. Since computers only deal with zeros and ones, that is two-state signal, positive (one) or none (zero), it as well can be said that the two-state signal can be high (one) low (zero), positive (one) negative (zero), etc., as long as the electronic circuitry is designed to interprets its meanings properly, its end results for human understandings is considered zeroes and ones. In the majority of the cases, computer's signal is five volts positive for one and zero volts for zero. There are quite a few electronic gates and they are the base for any digital-electronic circuitry. In our current illustration XORs are used, later on, other electronic gates will be used as well and they will be explained as needed. An XOR electronic gate will have an output value of “1” whenever one input is “0” and the other is “1” and it will the value of “0” for its output whenever the two inputs are of the same value.

Lets give in a more in depth explanation of device 100. The plainbytevalue 102 has the value of “1110” 114 in actuality it starts from the least significant bit (low bit value) to the most significant bit (high bit value). The same explanation applies to boxes 106, 110, 166, 172 and 178.

As we proceed, lets start with the top XOR gate 126 it has for its top input 122 bit “1′” (bit position value 8-104) and for its bottom input 124 it has bit “1” (bit position value 8-164) and its output is “0′” 126′ [1]. XOR gate 136 has for its top input 132 bit “1′” (bit position value 4-104) and for its bottom input 134 it has bit “0” (bit position value 4-164) and its output is “1′” 136′ [2]. XOR gate 146 has for its top input 142 bit “1′” (bit position value 2-104) and for its bottom input 144 it has bit “1” (bit position value 2-164) and its output is “0′” 146′ [3]. Lastly, XOR gate 156 has for its top input 152 bit “0′” (bit position value 1-104) and for its bottom input 154 it has bit “0” (bit position value 1-164) and its output is “0′” 156′ [4]. The outputs from XOR gates 126, 136, 146 and 156 become the first cipherbytevalue 106 it in turns becomes the top input for XOR gates 128, 138, 148 and 158 respectively.

Lets proceed with the next set of XOR gates. As we've already explained the top input bit value of gate 128 is the output bit value of gate 126 and it is “0′” (126′) and the bottom input bit “1” 128* (bit position value 8-170) and its output value is “1′” 128′ [1]. The top input bit value of gate 138 is the output bit value of gate 136 and it is “1′” (136′) and the bottom input bit “1” 138* (bit position value 4-70) and its output value is “0′” 138′ [2]. The top input bit value of gate 148 is the output bit value of gate 146 and it is “0′” (146′) and the bottom input bit “1” 148* (bit position value 2-170) and its output value is “1′” 148′ [3]. The top input bit value of gate 158 is the output bit value of gate 156 and it is “0′” (156′) and the bottom input bit “0” 158* (bit position value 1-170) and its output value is “0′” 158′ [4]. The outputs from XOR gates 128, 138, 148 and 158 become the second cipherbytevalue 110 it in turns becomes the top input for XOR gates 130, 140, 150 and 160 respectively.

Since the same explanation for the previous XOR gates 128, 138, 148 and 158 applies to the XOR gate group 130, 140, 150 and 160 lets just skip them and proceed to the their respective outputs and they represent the final encrypted byte value “0001” 120 for the input plainbytevalue 102. Lets review. The first set of XOR gate group has the plainbytevalue and the first byte value of the content private key for their input. Subsequent XOR gate group will receive the encrypted value for one of their input and the other input will be the next content-key byte value, thus, at each stage of the XOR gate group the previous value gets re-encrypted, producing the encryption strength. Its final output vale is the final encrypted byte value, the cipherbytevalue.

Decryption of the cipherbytevalue

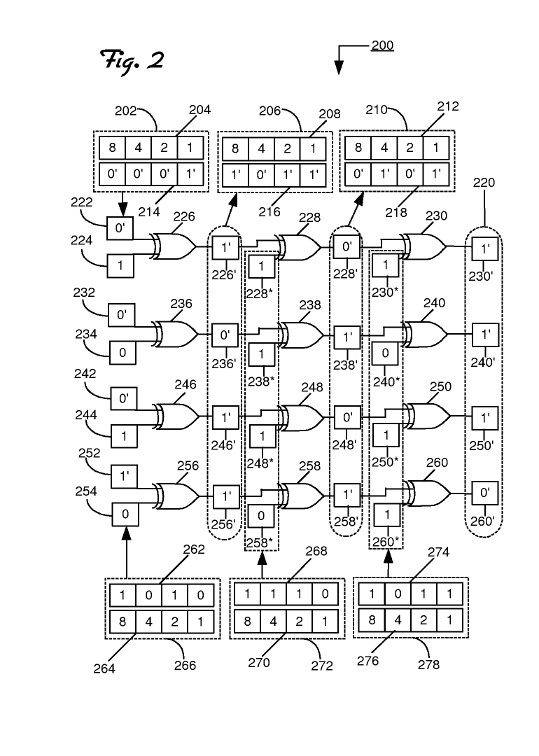

Lets turn our attention to FIG. 2 and it illustrates device 200 and it is has the same device electronic circuitry that has been explained for FIG. 1. Except, this time around, it will be used for the purpose of producing the original byte value. As we look back at FIG. 1 at the last XOR gate group output 120 and it's value is “0001”. As we proceed with FIG. 2, the output value 120 of FIG. 1 is now the input value of FIG. 2 202 bottom bit values 214. As we've already explained elsewhere, we've said that the digital content has a private key and it is used for the encryption of the digital-content stream, as for our explanation, only one byte is used. The content-private key bytes for FIG. 1 are 166, 172 and 178 and they are the same ones used for the content-private key for FIG. 2 and they are 266, 272 and 278. And they represent the same values. For the first byte value FIG. 1 166 is the same for FIG. 2 266, the second byte value FIG. 1 172 is the same second byte value FIG. 2 272 and the third byte value FIG. 1 178 is the same byte value FIG. 2 278.

Proceeding with FIG. 2 and as we've aforementioned, the output value 120 (FIG. 1) is now the input value of FIG. 2 202. Since we have already fully explained FIG. 1 and the same explanation applies to FIG. 2 as well, anyone with the skill in the art will be follow the explanation already given for FIG. 1 and fully understand the meaning of FIG. 2 as well, we'll simply move on to the output of the last XOR gate group 220. As we analyze it, it is the same original value of FIG. 1102 and it is “1110” and the same circuitry can be used in the sending and in the receiving devices, thus, decreasing device's manufacturing costs without compromising security.

As we've aforementioned when explaining “Diffie-Hellman Key Exchange Theory” that two people can exchange a common private key and it be used for encryption/decryption. In the above examples the same can be accomplished by having the Diffie-Hellman key exchange algorithm implemented on each device and the devices will automatically exchange the private keys and as the illustration of device 100 (FIG. 1) and device 200 (FIG. 2) the exchanged key is placed into the registers that will be used for encrypting and decrypting the content.

For the sake of our explanatory illustration, lets say that two devices are two cell phones. The first device 100 initiates the communication with the second device 200. After they exchange the private key, device 100 will send the first digital stream and as each byte of the digital stream is applied to the XOR gate group, the byte will be encrypted and re-encrypted for each byte value of the content private key. Once device 200 receives the encrypted data stream the same is applied to its electronic circuitry and as each encrypted byte value is is applied and subsequent re-applied using the same private key values the final value will the original byte value.

We've used the cell phone for our example, it is but one way of using this invention, it can be a two-radio, communication between two computers, etc. Instead of using between two devices as per our exemplary illustrations, it can be used for protecting content within a single device, like, personal computer, PDA, laptop computer, Smart Cards, etc. The plain data is applied to the circuitry before it is encrypted and after is encrypted it can be saved locally without any possibility of misuse. In the case of cell phone, the same circuitry can be used for protecting the communication data stream and for protecting local user-data. A user password can be used as the content-private key for encrypting/decrypting local content on cell phone and the exchanged private key for encrypting/decrypting the communication data stream. The aforementioned devices are for explanatory review only, it can be used in any conceivable device, we've used cell phone for sake of simplicity and not in any way intended to obscure this invention or limit its scope.

Encryption/Decryption Overview

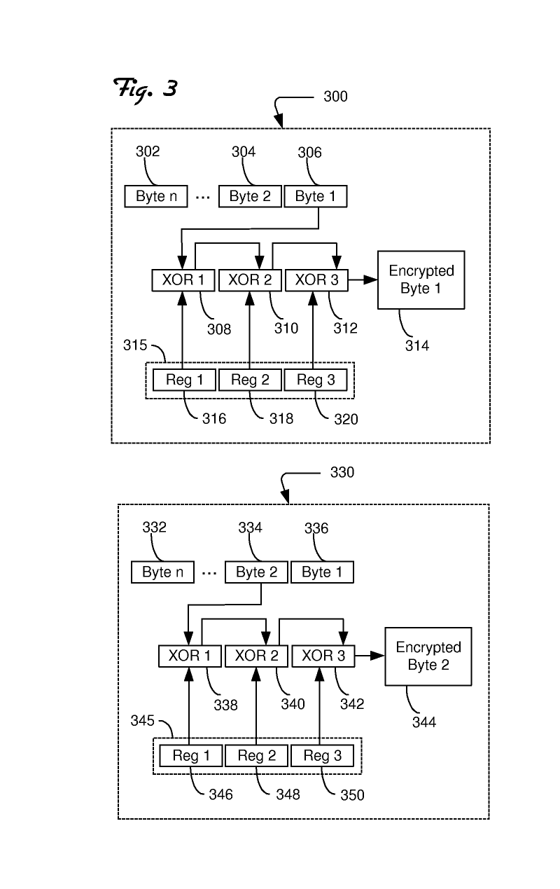

Let us now turn our attention to FIG. 3 and illustrates the digital logic 300 and it is a further embodiment of the device 100 of FIG. 1. At the top it illustrates a content stream having Byte 1 306, Byte 2 304 and Byte n 302. At the middle it illustrates the three XOR group that was illustrated in FIG. 1 and FIG. 2. Each byte of the register 315 is used to encrypt the plainbytevalue. The first Byte 1 306 is XORed (XOR 1 308) with the Reg 1 316. The XOR 1 308 feeds the next XOR 2 310 and the previous cipherbytevalue is re-XORed (XOR 2 310) with Reg 2 318. The same is true for the Reg 3 320 and XOR 3 312, XOR 3 312 is fed by the output of XOR 2 310. Finally, XOR 3's 312 output is the encrypted Byte 1 314 (cipherbytevalue). The digital logic 330 illustrates the encrypting of the next byte of the digital content stream and it is Byte 2 334. The same explanation for the digital logic 300 applies here as well and anyone with the skill of the art will be able to follow the previous explanation and apply it here as well.

Using the plainbytevalue for Encryption

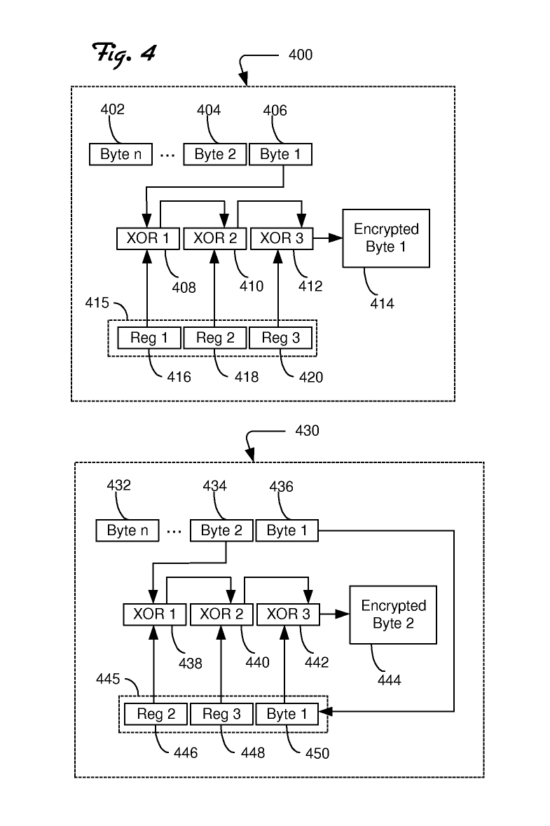

Let us now turn our attention to FIG. 4 and it illustrates digital logic 400 and it is the same digital logic 300 of FIG. 3 and the explanation of 300 applies here as well. Lets proceed with the digital logic 430 and it is very similar with digital logic 330 of FIG. 3, except that after the Byte 1 406 was encrypted 414, the Byte 1 436 (plain value) is now moved to the digital content key and placed at its rightmost position—it could've be to the leftmost position al well. As we analyze the register and compare it to the register 415, the Reg 1 416 is not present on the register 445, that is, the register 445 has been shift to the left to accommodate the new Byte 1 450. Now, the Byte 2 434 is encrypted with the Reg 2 446, Reg 3 448 and Byte 1 450.

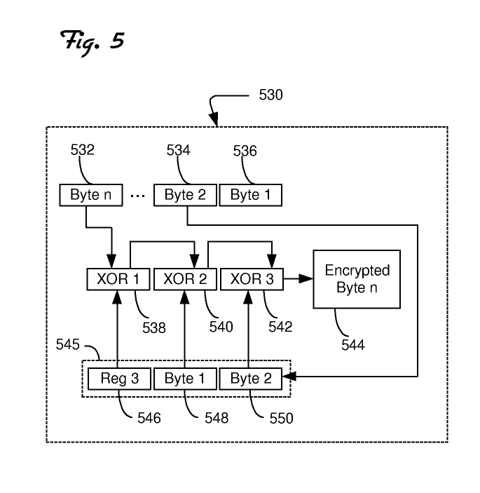

Turning our attention to FIG. 5 and it illustrates the last stage of the encryption. This time the Byte 2 534 is moved to the content-key register 545 and placed to the right of it, its bytes once again shifts to the left and now Byte n 532 gets encrypted with Byte 2 550, Byte 1 548 and Reg 3 546. This mechanism will allow shorter content keys to be used and still offering a high protection.

Using the plainbytevalue for Decryption

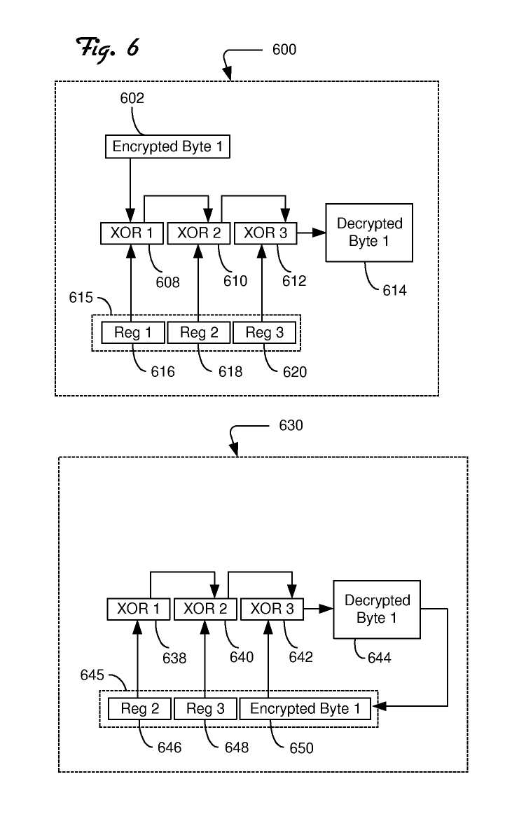

As we turn our attention to FIG. 6 and it illustrates the reverse process used for encrypting a plainbytevalue. Since the digital logic is the same used with other examples, let's concentrate our explanation of the decryption process only. As we saw while explaining the digital logic 400 FIG. 4 the Byte 1 406 was encrypted using all the values register's 415. Now, with the digital logic 600 (FIG. 6) the decryption of the Encrypted Byte 1 602 is the Encrypted Byte 1 414 of FIG. 4. And it was encrypted using all of the original registers of the register group 415 of FIG. 4, except they are now register group 615 of FIG. 6. Once the circuitry produces the Decrypted Byte 1 614 it is placed into the register at the rightmost position of it. The digital logic 630 illustrates it; Decrypted Byte 1 644 is placed at the register group 645 (650) and the register gets left shifted.

Proceeding with FIG. 7 and it illustrates the Encrypted Byte 2 702 is decrypted with the register's value of register 715 and having the Reg 1 716, Reg 2 718 and the Decrypted Byte 1 720; its correlating digital logic is the digital logic 430 of FIG. 4. The Decrypted Byte 2 744 is placed to the left 750 in the registers 745. Next, FIG. 8 illustrates the decryption of the Encrypted Byte n 832 and it is decrypted with the register's values of the register 845 using the Reg 3 846, Decrypted Byte 1 848 and Decrypted Byte 2 850; its correlating digital logic is the digital logic 530 of FIG. 5.

Protecting and Distributing Copyrighted Content

As we've aforementioned, we've said that this invention can be used for encrypting/decrypting and sharing copyrighted content without hindering legitimate user and on the other hand thwarting content piracy. It is the objective of the copyrighted content industry to offer such solution for their content user and it is the object of this invention as well, as we'll see shortly. Whence we explained “Checksum Theory” we learned that words, phrases and even a complete content could be summed and have the summed value as a key for the content. As well, we said that with a dual-key device ID protected contents could be exchanged between devices without infringing content holders rights.

The idea is that each device has two Ids, one is a checksum of the postal address where the device is located, it can be some or all of the postal information address of the device, let's call it “Address A” for the device A, and “Address A” for device B. The second ID is for the device's owner and it can be some or all of the user's profiling information, let's call it “User A” for device A and “User B” for device B. Now, if at least one ID from both devices produces an exactly match, the devices can exchange protected contents. As per the two mentioned devices, they both have “Address A” in common and the two users have different Ids. In the just mentioned scenario, the two devices can exchange protected content, since they both are at the same location, same home for instance. Now, if one address Id were, lets say, “Address C” then the two devices wouldn't exchange content because the reside at two different location and belonging to different users. If the two devices had two different address Ids but two user's ID of the same value, the two devices could exchange content as well. In the latter case, both devices belong to the same user.

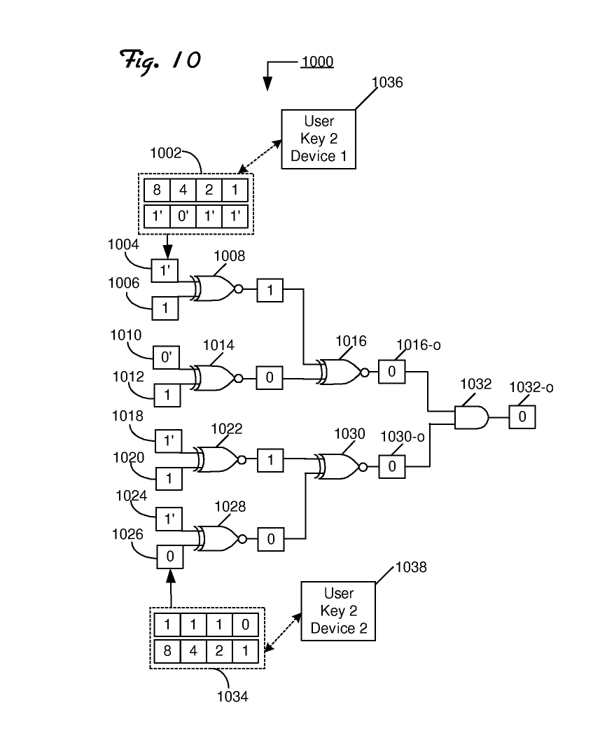

Let's forward to FIG. 12 and it illustrates what we've just described. The logic starts 1200 and the hosting device 1202 has two Ids, 1202a for the address and 1202b for the user. The receiving device 1204 has two Ids as well, 1204a for the address and 1204b for the user. Next, the address Ids (1^{st} ids) from both devices are compared 1206 and if they produce a match the content is allowed to be transferred 1208, or, once the user Ids (2^{nd} Ids) of both devices are compared 1210 and if they produce a match, the content is allowed to be transferred as well 1208, and lastly, if no match for any Ids of both devices the content is not allowed to be transferred and the process ends 1212.

Lets now turn our attention to FIG. 9 and it illustrates two registers 902 and 934 and they both represent the “Address” ID for both devices. The top 902 represents the “Address” ID for “Device 1” 936 and the bottom 934 represents the “Address” ID for “Device 2” 938. As for the top register 902 it illustrates the values of “1010”, and for the bottom register 934 it illustrates the values of “1010”, the values are the same. The comparator 908 (a comparator is an XOR with an inverter at its output) has for its input two values of “1” the top 904 from the register position (8) of register 902 and the bottom 906 input value has the register position (8) of register 934. Now the output value of the comparator 908 is “1” since both input values are of the same value of “1”. As for the next comparator 914 two alike values of “0” are present in its input 910 and 912, the top for the (4) in the left from register 902 and the bottom for the (4) position from the left from register 934. The explanation just given applies to the other two comparators, 922 and 928 as well.

The output of the top two comparators 908 and 914 are fed into another comparator 916, the same for the two bottom comparators 922 and 928, their output are fed into the comparator 930, they both (916 and 930) produce a “1” for their outputs. The two outputs of both comparators 916 and 930 are fed into an “AND” gate 932 and its output is “1”, thus the two registers values are exactly match. If we were using a complete byte value, eight bits, more comparators and “AND” gates would've been used.

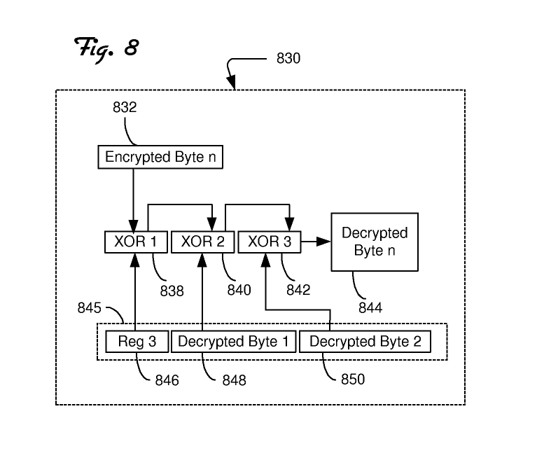

The explanation of FIG. 9 applies to FIG. 10 as well with the exception that the top register 1002 and the bottom register 1034 are not an exactly match, as well, the two registers represent the “User” Ids for both devices, top 1036 for device 1 and bottom 1038 for device 2. If we analyze comparator 1008 its output is “1” since both inputs are “1” 1004 and 1006, as for comparator 1014 its output is “0” since its input is “0” for the top 1010 and “1” for the bottom 1012. Once their outputs are fed into the comparator 1016 its output is “0” 1016-o, the same happens with the trio-comparators 1022, 1028 and 1030. Thus, the output of the “AND” gate 1032 is “0” 1032-o, indicating that the two register possesses two distinct values.

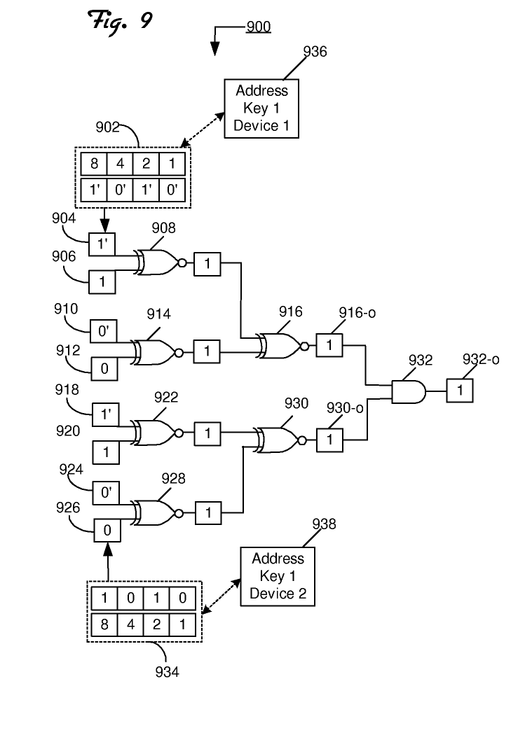

Lets now turn our attention to FIG. 11 and it illustrates a circuitry 1100 it is a further embodiment of FIG. 9 and FIG. 10. To the left we have the same two-key groups (938, 936, 1036 and 1038) and their respective outputs (916-o, 930-o, 1016-o and 1030-o) and these outputs are the outputs just before each AND gate (932 and 1032) for the each of the two-key groups. For each of the AND gate 932 and 1032, and their respective outputs (932-o and 1032-o) are illustrated as well, and they both becomes the input to the OR gate 1104 and its output will be “1” 1104-o whenever at least one of its input is “1”. The output 1104-o of the OR gate 1104 will enable the tri-state buffer group 1107 to pass its input 1106 to its output 1108. In case the output 1104-o of the OR gate 1104 is “0” the tri-state buffer group 1107 will not allow its input 1106 to pass out 1108, as already explained.

As already taught regarding the distribution of protected content, we've said that the device can have two keys, one in reference of the device's address and the other in reference of the device's owner. As well, we've taught that the devices having at least one register (it can have more than one as well, it will be taught shortly) that will do the encryption and decryption of protected content and that the transferring device will use the receiving device's keys as a means for enable or disabling the transfer of content (protected and non-protected) to the receiving device. This is but one way and many other ways can be devised and implemented as well and as we'll see shortly, each device in addition to the two keys already mentioned can have yet a third key and it is a key to identify the device itself, like, a serial number of the device or any other generated key implemented on the device's hardware.

As we now turn our attention to FIG. 13 and it illustrates two ways of transferring contents between two or more devices. Device 1300 is a “Content Hosting Server” and it can be any kind of device for the purpose of distributing content to other devices. As it is illustrated, it has a single-encrypted content 1304 and the content 1304 having a “Content ID A” 1302. Only one content is illustrated for sake of simplicity, it can have any number of contents and the server 1300 can be in a network or over the internet and it acts as a content distributor. Now, as illustrated content 1304 is already encrypted, this is but one way, it can be in its original un-encrypted form as well, since it is in the content-distributor server, and in most of the cases it will have its own means for protecting against content misuse.

Proceeding, the Encrypted Content A 1304 is being transferred to the “Content Loading Device A” 1320 and the device 1320 is the receiving device, it can be any kind of electronic device, a computer, a music/video device, a TV top set box, a stereo player, etc. As per the illustration herein, the device 1320 receives the “Encrypted Content A” 1324 and it has a content key 1322 and as we analyze it, it has the “Device ID A+Content ID A” 1322 and it means that the received content now has the original “Content ID A” 1302 and the device's 1320 ID. As we've aforementioned, that each device can have a third ID and it will represent the device itself, in the just illustrated arrangement, the first device 1300 will receive the Device A ID 1320 and encrypt it with the Content A ID 1302 and send the encrypted content 1304 that has been encrypted with the “Content ID A” 1302 along with the encrypted “Content ID A” 1302 and the device's 1320 ID to the device 1320. The encryption used to encrypted the content ID and the receiving device's ID can be XOR or any other means that will achieve the same end result. We'll be using the XOR for our explanation.

The receiving device 1320 can be arranged to have two-registers key as we've already mentioned and once it uses the content, the received content's key 1322 can be placed on the first content register and the device's 1320 key (the key representing the device) can be placed in the second register. The first register will decrypt the received content 1324 and it will still have the receiving device's 1320 ID, once the content passes through the second register, the receiving device's ID will be removed and having the original content reproduced and ready for use by the receiving device 1320. If on the other hand, the content 1304 is in its original form without any encryption, the receiving device's 1320 key can be used by device 1300 to encrypt content A 1304 and send it to device 1320, then device 1320 will place its key in one of its registers and have the encrypted content decrypted. In the just mentioned example, the receiving device will be using a single encryption/decryption register.

As we proceed, device 1320 is illustrated transferring content to yet a third device 1340 and the third receiving device 1340 receives the “Encrypted Content A” 1344 and the new content key will have the content key 1322 of device 1320 and the third receiving device 1340 ID and the content A's ID 1342 will be “Device ID A+Content ID A+Device ID B” now the third receiving device 1340 will place ID 1342 in the first encryption/decryption register and decrypt content A 1344 and still leaving the third device's 1340 ID as part of the content A 1344, next, the third device 1340 will place its ID into the second register and it will once more decrypt the content A 1344 thus removing the third receiving device's ID 1340 from content A 1344 it will be ready for use.

Lets continue with the second arrangement and it is very similar to the first one. Device 1310 is basically the same device 1300 with only one difference. Once device 1330 requests content A 1314, it will encrypted an additional key (Random ID) and as it is illustrated at the receiving device 1330 content ID 1332 it has “Device ID A+Random ID+Content ID A” and the same content A 1334. As with device 1320, if its ID is XORed with the received content ID 1322, the original content A 1324 ID can be made know and the just retrieved content A ID can be used (XOR with content A) to decrypt content A and have its security removed. Back to the second arrangement and if the same method is used with content ID 1332, the randomly generated ID will be missing to an eavesdropper, now it can be the one exchanged between the two devices as explained while explaining “Diffie-Hellman Key Exchange Theory” and in this case both devices will have the random key. The explanation already given for the first arrangement applies to the last part of the second arrangement as well. Anyone skilled in the art will be able to apply it's teaching here and understand it therefore.

As by the illustration of FIG. 1, FIG. 2, FIG. 9, FIG. 10, FIG. 11 and FIG. 13, it was taught how protected (encrypted) copyrighted content can easily and securely be transferred between devices without infringing copyrights or downgrading security, by using a two device's keys. Now the keys that we've presented were based on checksum of the device's address and the device's owner, it is but one way, other ways can be devised as well without departing of the true scope of the present invention. Also, the same methods can be used for any kind of content as well and the content being transferred don't need to be encrypted. We've used “Diffie-Hellman Key Exchange” for exchanging a common key between devices, other means can be used as well without departing from the teaching and scope of the present invention, as well, each device can have other means of protection as well like a public key encryption implement therein in addition to “Diffie-Hellman” or instead of.

Furthermore, from the illustration of FIG. 1 and FIG. 2 and through their respective illustrations it was depicted how to use a content key to protect content on the hardware level and as it is known to those of the skill in the art, it is but one way, the same method can be implemented using software without departing from the true scope and spirit of the present invention. Also, a means for protecting content using the content plainbytevalue as part of the encryption/decryption registers for encrypting/decrypting said content.

### CONCLUSION

A method and an apparatus for protecting content and data stream between devices were presented where a content private key is used in electronic-digital registers for providing the content's encryption strength. As well, means for transferring protected copyrighted content between devices using a dual-device's IDS without hindering legitimate user while thwarting content piracy. The same teachings apply to uses in a software program—or a combination of software/hardware—without departing from the true spirit and scope of the present invention.

Although the present invention and its advantages have been described in detail, it should be understood that various changes, substitutions and alterations could be made herein without departing from the true spirit and scope of the invention as defined by the appended claims. Moreover, the scope of the present application is not intended to be limited to the particular embodiments of the process, machine, manufacture, composition of matter, means, methods, computer software and steps described in the specification. As one of ordinary skill in the art will readily appreciate from the disclosure of the present invention, processes, machines, manufacture, compositions of matter, means, methods, computer software, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, computer software or steps.

What is claimed is:

1. A protected content, comprising:
at least a first computer having at least a first tangible media;
at least one content stored at said at least first tangible media at said at least first computer having at least a first byte;
a means to encrypt/decrypt, said means to encrypt/decrypt is a XOR operation;
said content having a first-content key;
said first-content key having at least a first byte;
said at least first byte of said at least one content is encrypted with said at least first byte of said first-content key using said means to encrypt/decrypt and producing a first cipherbytevalue;
said first-content key further having at least a second byte; and
said first cipherbytevalue is encrypted with said at least second byte of said first-content key using said means to encrypt/decrypt and producing a second cipherbytevalue.

2. The protected content according to claim 1, further comprising:
said at least first computer having a first identification key, said first identification key is based at least one element of a postal address location where said first computer is located.

3. The protected content according to claim 1, further comprising:
said at least first computer having a first identification key, said first identification key is based at least one element of a personal profiling information of said first computer's owner.

4. The protected content according to claim 1, further comprising:
said at least first computer having a first identification key, said first identification key is based on said first computer's ID.

5. The protected content according to claim 1, further comprising:
said at least first byte of said at least one content is integrated with at least one byte of said at least two bytes of said first-content key and the other byte of said at least two bytes of said first-content key is discarded;
said content further having at least a second byte;
said at least second byte of said content is encrypted with the remaining byte of said first-content key that wasn't discarded using said means to encrypt/decrypt and producing a third cipherbytevalue; and
said third cipherbytevalue is encrypted with said at least first byte of said content taking part of said first-content key using said means to encrypt/decrypt and producing a fourth cipherbytevalue.

6. The protected content according to claim 5, further comprising:
said at least first computer having a first identification key, said first identification key is based at least one element of a postal address location where said first computer is located.

7. The protected content according to claim 5, further comprising:
said at least first computer having a first identification key, said first identification key is based at least one element of a personal profiling information of said first computer's owner.

8. The protected content according to claim 5, further comprising:
said at least first computer having a first identification key, said first identification key is based on said first computer's ID.

9. The protected content according to claim 5, further comprising:
at least a second computer;
said at least first computer and said at least second computer having means to communicated with each other;
said at least second computer having means to encrypt/decrypt, said means to encrypt/decrypt is a XOR operation;
said at least second computer having said at least first byte and said at least second byte of said first-content key stored therein as a second-content key;
said at least second computer used said means to communicate with said at least first computer and receives said at least second cipherbytevalue from said at least first computer;
said second cipherbytevalue is decrypted with said at least first byte value of said second-content key stored at said at least second computer using said means to encrypt/decrypt and producing a fifth cipherbytevalue; and
said fifth cipherbytevalue is decrypted with said at least second byte value of said second-content key stored at said at least second computer using said means to encrypt/decrypt and producing the value of said at least one byte of said at least one content stored at said at least first tangible media at said at least first computer before it was first encrypted as a second plainbytevalue;
said second plainbytevalue is integrated with at least one byte of said at least two bytes of said second-content key and the other byte of said at least two bytes of said second-content key is discarded;
said second computer uses said means to communicated with said first computer and receives said forth cipherbytevalue;
said forth cipherbytevalue is decrypted with the remaining byte of said second-content key that wasn't discarded using said means to encrypt/decrypt and producing a sixth cipherbytevalue; and
said sixth cipherbytevalue is decrypted with said at least first byte of said second plainbytevalue of said second-content key using said means to encrypt/decrypt and producing a third plainbytevalue and said third plainbytevalue is the same said second byte of said content hosted by said first computer before it was encrypted.

10. The protected content according to claim 9, further comprising:
said at least first computer having a first identification key, said first identification key is based at least one element of a postal address location where said first computer is located.

11. The protected content according to claim 9, further comprising:
said at least first computer having a first identification key, said first identification key is based at least one element of a personal profiling information of said first computer's owner.

12. The protected content according to claim 9, further comprising:
said at least first computer having a first identification key, said first identification key is based on said first computer's ID.

13. The protected content according to claim 9 wherein said second-content key was received from said at least second computer.

14. The protected content according to claim 9 wherein said first-content key and said second-content key were exchanged between said at least second computer and said at least first computer using said means to communicated between said at least first computer and said at least second computer using a algorithm common to both computers.

15. The protected content according to claim 1, further comprising:
at least a second computer;
said at least first computer and said at least second computer having means to communicated with each other;
said at least second computer having means to encrypt/decrypt, said means to encrypt/decrypt is a XOR operation;
said at least second computer having said at least first byte and said at least second byte of said first-content key stored therein as a second-content key;
said at least second computer used said means to communicate with said at least first computer and receives said at least second cipherbytevalue from said at least first computer;
said second cipherbytevalue is decrypted with said at least first byte value of said second-content key stored at said at least second computer using said means to encrypt/decrypt and producing a third cipherbytevalue; and
said third cipherbytevalue is decrypted with said at least second byte value of said second-content key stored at said at least second computer using said means to encrypt/decrypt and producing the value of said at least one byte of said at least one content stored at said at least first tangible media at said at least first computer before it was first encrypted.

16. The protected content according to claim 15, further comprising:
said at least first computer having a first identification key, said first identification key is based at least one element of a postal address location where said first computer is located.

17. The protected content according to claim 15, further comprising:
said at least first computer having a first identification key, said first identification key is based at least one element of a personal profiling information of said first computer's owner.

18. The protected content according to claim 15, further comprising:
said at least first computer having a first identification key, said first identification key is based on said first computer's ID.

19. The protected content according to claim 15 wherein said second-content key was received from said at least second computer.

20. The protected content according to claim 15 wherein said first-content key and said second-content key were exchanged between said at least second computer and said at least first computer using said means to communicated between said at least first computer and said at least second computer using a algorithm common to both computers.

21. A means for transferring content, comprising:
at least a first apparatus;
said at least first apparatus having two keys;
said at least first apparatus having at least a first tangible media;
at least one content stored at said at least first tangible media at said at least first apparatus;
at least one key of said first apparatus' two keys is based on at least one postal address element of where said first apparatus is located; and
at least one additional key of said first apparatus' two keys is based on at least one profiling element of the owner of said first apparatus.

22. The means according to claim 21, further comprising:
said at least first apparatus further having a third ID and said third ID is a means for identifying said first apparatus

23. The means according to claim 21, further comprising:
at least a second apparatus;
said at least second apparatus having two keys;
at least one key of said second apparatus' two keys is based on at least one postal address element of where said second apparatus is located;
at least one additional key of said second apparatus' two keys is based on at least one profiling element of the owner of said second apparatus;
said second apparatus having means to communicate with said first apparatus, said second apparatus uses said communication means and requests said at least one content stored at said at least first tangible media at said at least first apparatus;
said first apparatus uses said communication means and requests and receives from said second apparatus said second apparatus two Ids; and
said first apparatus compares each of the received ID from said second apparatus with an equivalent ID from said first apparatus and if at least one of the received ID from said second apparatus has the same value as of one equivalent ID from said first apparatus, said first apparatus transmits said at least one content to said second apparatus.

24. The means according to claim 22, further comprising:
said at least second apparatus further having a third ID and said third ID is a means for identifying said second apparatus

25. A means for exchanging content, comprising:
at least a first apparatus;
said at least first apparatus having and ID, said ID is a means for identifying said at least first apparatus;
said at least first apparatus having two registers as means for storing two string values;
said two values are the means for encrypting/decrypting content, said means to encrypting/decrypting is a XOR operation;

26. A means for exchanging content according to claim 25, further comprising:
at least a second apparatus, said at least second having at least one tangible media;
at least one content;
said at least second apparatus having means for encrypting/decrypting content, said means for encrypting/decrypting is a XOR operation;
said second apparatus having at least one tangible;
a unique key representing said at least one content;
said at least second apparatus uses said means to encrypt/decrypt and encrypt said at least one content with said unique key representing said at least one content;
said encrypted content is stored at said at least one tangible media of said at least second apparatus along with said unique key represent said at least one content;
said at least first apparatus and said at least second apparatus having means to communicate with each other;
said at least first apparatus uses said communication means and initiates a communication with said at least second apparatus and requests said at least one encrypted content stored at said at least one tangible of said at least second apparatus;
said second apparatus uses said communication means requests and receives said at least first apparatus's ID;
said at least second apparatus uses said means to encrypt/decrypt and encrypts said unique key representing said at least one content with said received first apparatus ID as encrypted content key;
said at least second apparatus returns to said at least first apparatus said requested encrypted content along with said encrypted content key;
said at least first apparatus receives said encrypted content key and stores it one of said two register;
said at least first apparatus stores said first apparatus' ID in the other register of said two registers;
said at least first apparatus receives said encrypted content and uses said means to encrypt/decrypt and decrypts said received encrypted content with one register of said two registers producing the cipher content; and
said at least first apparatus uses said means to encrypt/decrypt and decrypts said cipher content with the other register of said two registers that didn't take place in producing said cipher content and produces the decrypted content in its original form before it was first encrypted with said unique key representing said at least one content by said at least second apparatus.
